(19) United States
(12) Patent Application Publication
(10) Pub. No.: US 2013/0279006 A1
(43) Pub. Date: Oct. 24, 2013

(54) STACKABLE NARROWBAND FILTERS FOR DENSE WAVELENGTH DIVISION MULTIPLEXING

(71) Applicants: DARYUAN SONG, IRVINE, CA (US); YUNG-CHIEH HSIEH, SAN JOSE', CA (US)

(72) Inventors: DARYUAN SONG, IRVINE, CA (US); YUNG-CHIEH HSIEH, SAN JOSE', CA (US)

(21) Appl. No.: 13/924,598

(22) Filed: Jun. 23, 2013

Related U.S. Application Data
(63) Continuation-in-part of application No. 13/660,909, filed on Oct. 25, 2012.
(60) Provisional application No. 61/551,428, filed on Oct. 25, 2011.

(51) Int. Cl. G02B 1/10

(52) U.S. Cl. CPC G02B 1/10
USPC 359/584; 156/264

(57) ABSTRACT

A plane-parallel optical window is the spacer of single-cavity filters in the stack used for DWDM applications. Highly reflective quarter-wave stacks are deposited on each side of the optical window and the single-cavity structure so obtained is diced to produce a plurality of filters. Each single-cavity filter so fabricated from the optical window has the same transmission wavelength and is therefore readily stackable for DWDM applications. Alternatively, an optical window with a thickness equal to one half that required for the spacer of a single-cavity filter is coated on a single side. The window is then divided in multiple identical components that can be combined in pairs by placing them in optical contact so as to form individual single-cavity filters with the same transmission-peak wavelength. The transmission peak of the filter can be fine tuned by controlling the temperature of the solid spacer material.

### RELATED APPLICATIONS

This application is a continuation-in-part application of U.S. Ser. No. 13/660,909, filed on Oct. 25, 2012, which is based on and claims the priority of U.S. Provisional Application Ser. No. 61/551,428, filed Oct. 25, 2011.

### BACKGROUND OF THE INVENTION

1. Field of the Invention

This invention relates to the general field of telecommunications and, in particular, to multi-layered thin-film optical filters used in dense wavelength division multiplexing (DWDM) for telecommunications.

2. Description of the Prior Art

In optical communications, one fiber can carry many communication channels where each channel has its own carrier frequency. The light of different frequencies is merged into the fiber through a device called multiplexer (“mux”) in the art and is later separated into different ports through a device called de-multiplexer (“de-mux”). Mux and de-mux devices typically utilize technologies such as thin-film filters to isolate the wavelengths of interest; in telecommunications these are the frequencies set by the International Communication Union, the ITU grid.

A commonly used optical filter is based on the structure of the so-called Fabry-Pérot etalon, which is typically made of a transparent spacer with two reflective surfaces. The pacer defines the cavity of the etalon. For telecommunication applications, the spacer is a thin layer of dielectric material with a half-wave optical thickness tuned to the wavelength of the transmission peak of interest and the reflective surfaces are quarter-wave stacks with a broadband reflectance peaking at the design wavelength. The quarter-wave stacks and the dielectric spacer between are fabricated in successive continuous deposition steps and two or more such filters can be deposited on top of each other separated by so-called absentee layers to form multiple-cavity filters.

As illustrated in FIG. 1, increasing the number of cavities has a significant effect on the shape of the passband with desirable characteristics for telecommunication applications. The band slopes are steeper, the near-band rejection is improved, and the passband peaks are flatter, nearly square. Therefore, stacks of at least two Fabry-Pérot etalons are usually used in each optical telecommunications filter.

In theory, so long as the optical thickness and phase of each half-wave stack spacer is the same, the transmission wavelength of each cavity will be the same. However, because the wavelength of the transmission peak of each etalon structure is very sensitive to minor differences in the structure of the spacer and the reflective surfaces, the passband peaks of stacked etalons are not always aligned and the resulting dichroic filter is often not suitable for telecommunication applications. Currently, the spacer of Fabry-Perot interferometers used in dense wavelength division multiplexing (DWDM) filters is only a few microns thick, but for some applications the spacer needs to be much greater. The traditional deposition method for making such thicker-spacer filters does not work because of the resulting structural non-uniformities and the attendant differences in transmittance. Thus, there continues to be a need for an economical and practical method for making such stackable filters and the present invention provides and alternative filter structure and method of fabrication that overcome these problems.

### SUMMARY OF THE INVENTION

The invention lies in the idea of using a plane-parallel optical window, instead of dielectric material deposited with the reflective coatings, as the spacer of each filter in the stack used for DWDM applications. In the simplest embodiment, the optical window has a half-wave thickness and the highly reflective quarter-wave stacks are deposited on each of its polished sides. The optical window has a much larger area than that of a single filter, thereby obtaining a large coated optical window from which many single-cavity filters can be produced. Because the resulting half-wave spacer has the same thickness over the entire window area and the quarter-wave-stack deposition process is carried out throughout under the same conditions, each single-cavity manufactured from the optical window has the same transmission wavelength within the range of interest and is therefore readily stackable for DWDM applications.

In another embodiment of the invention, the optical window is selected with a thickness equal to one half of that required for a half-wave plate and is coated with a quarter-wave stack reflector on a single side. That further diminishes the opportunity for non-homogeneities in the structure of the coated plate because of the single deposition step instead of the two steps required to coat both sides of the optical window. The window is then divided in multiple identical components that can be combined in pairs by placing them in optical contact so as to form individual single-cavity filters with a resulting half-wave spacer and the same transmission wavelength. These filters are advantageously similarly stackable for DWDM applications.

In either embodiment of the invention, a material that is optically sensitive to thermal variations is preferably used to fabricate the stack, so that the transmission peak can be maintained at a desired set-point by a temperature control system coupled to the filter. A heater, an energy source for the heater, a thermistor to measure the filter temperature, and a processor/controller can be used in conventional feedback-control manner to tune and maintain the filter's transmission peak at the desired wavelength.

Various other advantages will become clear from the description of the invention in the specification that follows and from the novel features particularly pointed out in the appended claims. Therefore, to the accomplishment of the objectives described above, this invention consists of the features hereinafter illustrated in the drawings, fully described in the detailed description of the preferred embodiments, and particularly pointed out in the claims. However, such drawings and descriptions disclose only some of the various ways in which the invention may be practiced.

### BRIEF DESCRIPTION OF THE DRAWINGS

FIG. 1 illustrates the effect of stacking identical thin-film filters on the shape of the normalized transmittance as measured by its deviation from the center wavelength in full-width-at-half-maximum (FWHM) units.

FIG. 2 is a schematic cross-section of a conventional Fabry-Perot thin-film filter manufactured by the sequential deposition of a reflective coating, a dielectric spacer and another reflective coating over a transparent substrate.

FIG. 3 is a schematic cross-section of a Fabry-Perot filter manufactured according to the invention by the deposition of a reflective coating over both sides of an optical window.

FIG. 4 is a schematic cross-section of a Fabry-Perot filter manufactured according to another embodiment of the invention by the deposition of a reflective coating over a single side of an optical window and the subsequent combination of two sectioned components to form the etalon spacer of the filter.

FIG. 5 illustrates a two-cavity stack of filters as shown in FIG. 3 or FIG. 4 coupled through an absentee layer.

FIGS. 6A, 6B and 6C illustrate a single-cavity structure suitable for manufacturing a two- or three-cavity stack with absentee layers.

FIGS. 7A, 7B and 7C illustrate another single-cavity structure suitable for manufacturing a two- or three-cavity stack with absentee layers.

FIG. 8 is a flow-chart of the steps involved in one embodiment of the process of the invention.

FIG. 9 is a flow-chart of the steps involved in another embodiment of the process of the invention.

FIG. 10 is a schematic representation of a filter according to the invention wherein the solid spacer is coupled with a temperature control system for fine tuning and maintaining the filter's wavelength peak of transmission.

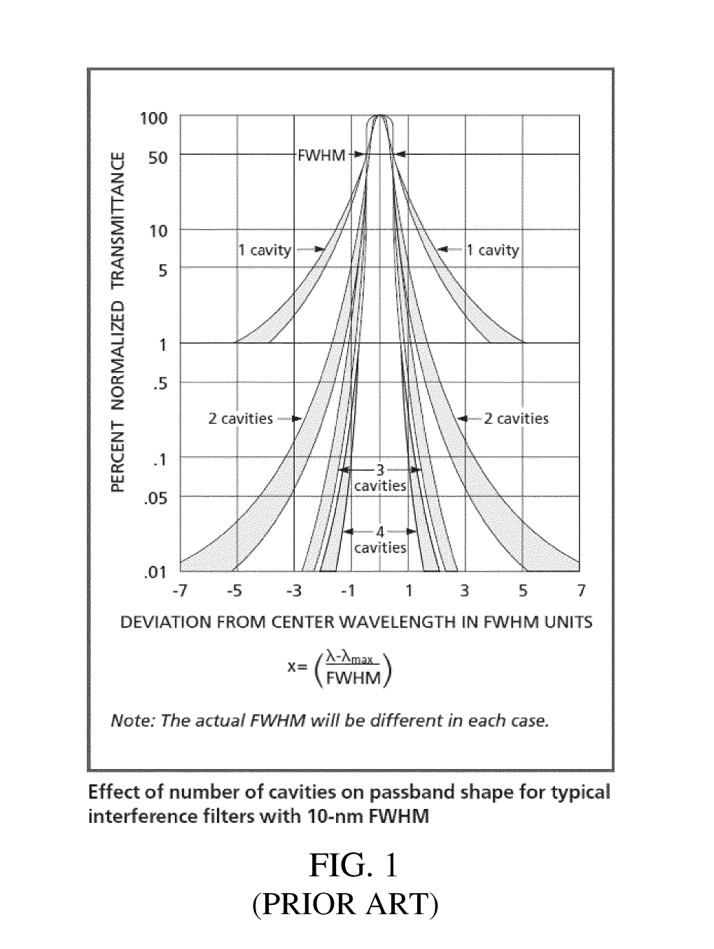

### DETAILED DESCRIPTION OF THE INVENTION

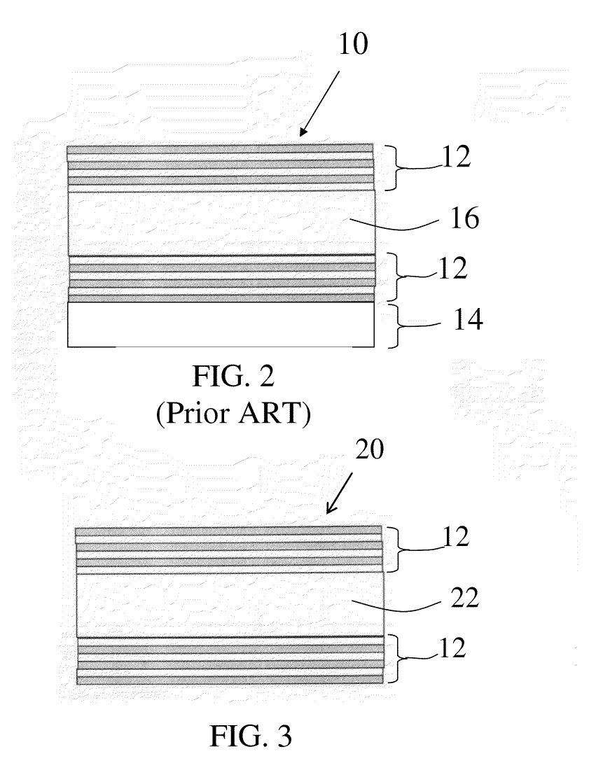

Referring to the figures, wherein like parts are designated throughout with like numerals and symbols, FIG. 2 illustrates schematically the structural components of a conventional thin-film filter 10 manufactured by sequential deposition of the various layers. A quarter-wave reflector coating 12 is first deposited over a transparent substrate 14, followed by a half-wave dielectric spacer layer 16, and then another quarter-wave reflector layer 12. (Those skilled in the art will recognize that the relative thicknesses of the spacer layer and the reflector coatings are not shown to scale but are exaggerated for the reflector stacks for greater ease of illustration and clarity.) When multi-cavity filters are produced, this sequence of deposition is repeated after the deposition of an absentee layer between cavities, which can lead to small differences in the stacked cavities on account of imperfections and variations in the deposition conditions during the various stages of fabrication. As a result, the passband peaks of stacked etalons may not be aligned and the filter would not be suitable for telecommunication applications

FIG. 3 shows, in contrast, the structure of a filter 20 manufactured according to the invention. A plane-parallel optical window 22 made of bulk dielectric material replaces the half-wave dielectric spacer layer 16 conventionally formed by deposition over the first reflective layer 12. Instead, the quarter-wave stacks 12 are deposited directly on each side of the optical window 22, thereby producing a complete single-cavity filter. If the optical window is much wider than the size (area) needed for a filter, the single-cavity so produced can be sectioned to obtain many substantially identical single-cavity filters. Because the optical window is parallel and sized to yield a half-wave optical spacer, it has the same thickness over the entire window area and each single-cavity filter obtained from it with have the same transmission wavelength. Note that in fact the transmission characteristics are periodic and repeated according to the FSR of the filter, but a single transmission-peak wavelength is of interest for telecommunication purposes; therefore, only that wavelength is referred to herein for simplicity.

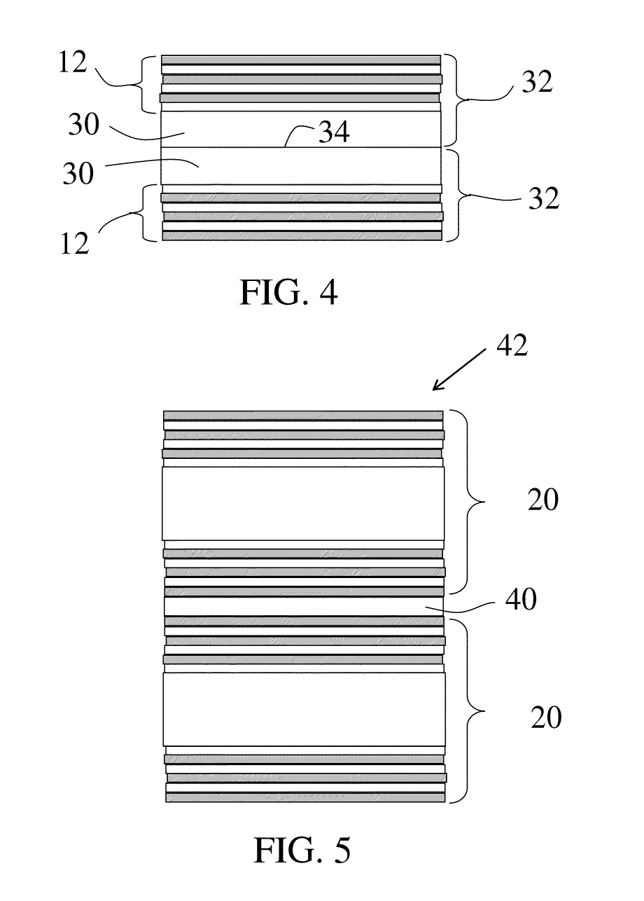

A comparable result can be obtained by coating a single side of an optical window 30 to produce an intermediate structure 32 for a half-wave filter etalon. Two such structures 32 can be bonded together along their uncoated surface 34 and then diced as needed to manufacture a filter of a given smaller size, as shown in FIG. 4. Alternatively, the coated optical window 30 can first be diced and then two portions from the same window bonded together to yield a single-cavity filter.

When the spacer of a Fabry-Perot interferometer is relatively thick (e.g., 50 um), it becomes impractical and uneconomical to manufacture it by deposition because of the length of deposition time and the degraded quality of very thick deposited films. The insertion loss becomes much greater than that of bulk material of the same thickness. For example, as illustrated in the tables below for a free spectral range (FSR)=400 GHz, the spacer thickness for silicon is 107 μm and or BK7 glass is 250 μm. Therefore, using an optical window as the spacer has tremendous advantages. No lengthy deposition process is needed and the spacer will automatically have the same uniform properties throughout as the bulk material of the window.

BK7 Glass and Silicon Spacer Thickness as a Function of FSR

### BK7

| FSR | | Refractive | Thickness | dL | Wavelength | shift |
|---|---|---|---|---|---|---|
| [GHz] | [pm] | index | [mm] | [um] | [nm] | [pm] |
| 100 | 800 | 1.5 | 1.000 | 0.002 | 1550 | 3.10 |
| 200 | 1600 | 1.5 | 0.500 | 0.002 | 1550 | 6.20 |
| 400 | 3200 | 1.5 | 0.250 | 0.002 | 1550 | 12.40 |

### Silicon

| FSR | | Refractive | Thickness | dL | Wavelength | shift |
|---|---|---|---|---|---|---|
| [GHz] | [pm] | index | [mm] | [um] | [nm] | [pm] |
| 100 | 800 | 3.5 | 0.429 | 0.002 | 1550 | 7.23 |
| 200 | 1600 | 3.5 | 0.214 | 0.002 | 1550 | 14.47 |
| 400 | 3200 | 3.5 | 0.107 | 0.002 | 1550 | 28.93 |

The shift in wavelength as a function of changes dL in the thickness of the spacer of a Fabry-Perot etalon is given by the relation

Shift=wavelength×dL/L,

where L is the thickness of the spacer. The free spectral range FRS=c/(2nL). Therefore, the tables above show that the thickness variation (dL) of the spacer needs to be kept at a minimum, in the order of few nanometers, in order to have a small enough wavelength shift to allow stacking of filters for DWDM applications. This can be easily achieved using a plane-parallel optical window as the etalon spacer, but not so by deposition of the spacer. Therefore, multiple filters obtained from the same window can be stacked successfully for DWDM applications so long as the parallelism of the window is well controlled. On the other hand, it is extremely difficult to match two windows produced separately within such a tight thickness tolerance.

Moreover, to achieve a two-cavity filter, two single-cavity filters can simply be bonded using a fusion bonding or other conventional process, for example. In practice, two large portions of a cavity 20 composed of a coated window can be bonded together, as illustrated in FIG. 5, with an intermediate absentee layer 40 and then diced as needed to manufacture a two-cavity filter 42 of a given smaller size. The same can be done with the single-cavity filter of FIG. 4. Thus, the invention avoids the most difficult part in manufacturing multi-cavity filters, which is controlling the thickness of the spacers and matching of individual half-wave filters so that stacking them produces a two- or more-cavity filter with a single passband peak (that is, the peaks of all cavities are aligned along a single wavelength). As a result, the filter performance and the yield are significantly improved by the invention.

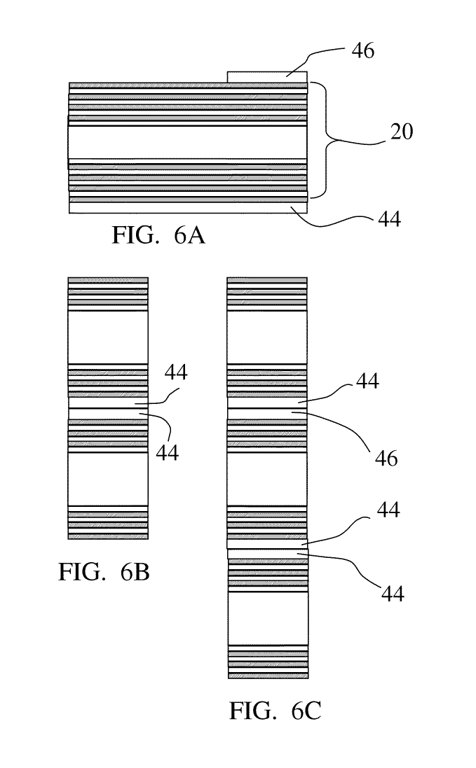

The deposition of the absentee layer is preferably carried out over the reflector layer or layers deposited over the window. In one embodiment, illustrated in FIG. 6A with reference to the single-cavity 20 of FIG. 3, one side of the coated structure is further coated entirely with absentee material to form a layer 44, while the other side is only partially coated with a smaller-in-area absentee layer 46 using a mask during the coating process. The resulting structure can then be diced and the individual single-cavity portions combined to form either two- or three-cavity filters, as illustrated in FIGS. 6B and 6C, simply by appropriately placing reflector layers in contact with the absentee layers so deposited.

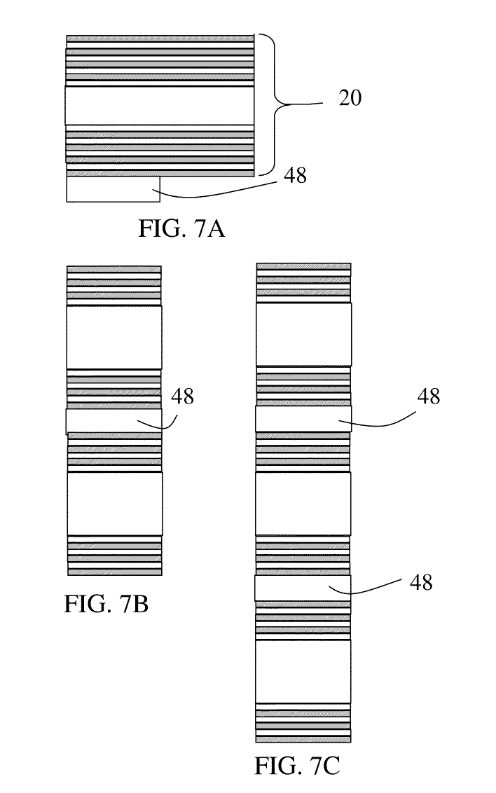

In another embodiment, illustrated in FIG. 7A with reference to the same single-cavity 20 of FIG. 3, only one side of the coated structure is further coated with absentee material, but only over a portion of the entire area to form a layer 48 of absentee material using a mask while leaving the other portion of the area uncoated during the coating process. The resulting structure can then be diced and the individual single-cavity portions combined to form either two- or three-cavity filters again by appropriately placing reflector layers in contact with the absentee layers so deposited, as illustrated in FIGS. 7B and 7C. Obviously, the preferred size of the portion to be coated will depend on whether the manufacture of two- or three-cavity filters is planned.

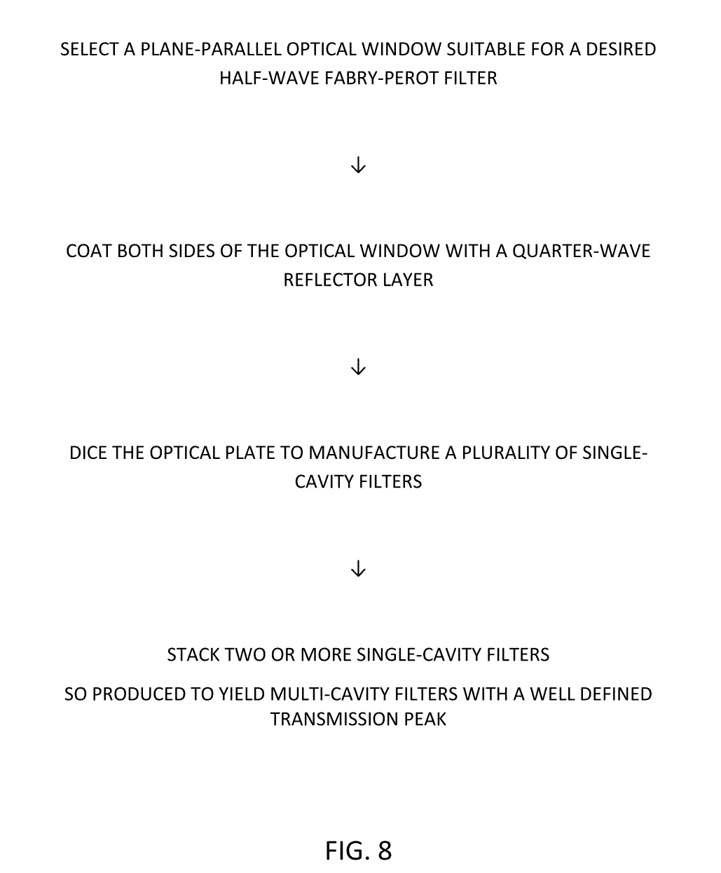

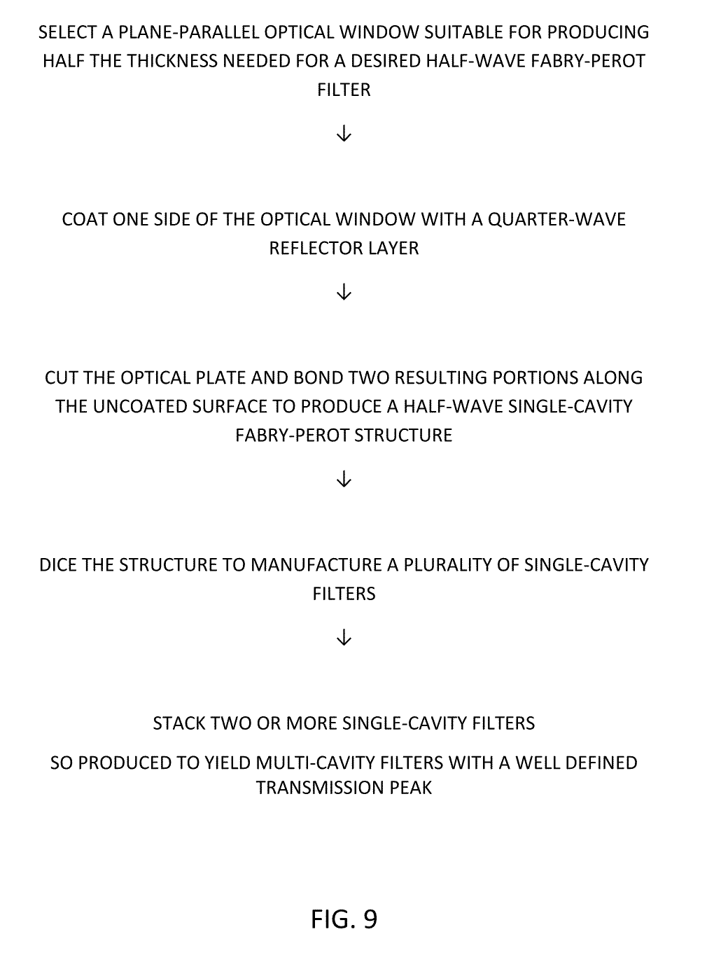

FIGS. 8 and 9 outline the steps involved in manufacturing multiple-cavity filters using each of the two fabrication processes described above. The details of the various steps, such as dicing of the optical window and bonding of the resulting components, are conventional and well known in the art. For example, the uncoated surface of the optical window is preferably polished prior to coating and bonding.

The use of plane-parallel optical windows affords another valuable advantage over the traditional method of filter manufacture. Inasmuch as the filter consists of solid etalon cavities made of a spacer material with a refractive index that is temperature sensitive, such as silicon, this property can be exploited advantageously to provide fine filter tuning. It is known that the wavelength of the transmission peak is related to temperature changes by the following relationship,

Δλ=λ[(dn/dT+n×α)/n]ΔT,

where λ is wavelength, n is refractive index, T is temperature, dn/dT is thermal coefficient of refractive index, and α is the thermal expansion coefficient. For example, at λ=1,550 nm, for silicon with n=3.5, α=2.6×10⁻⁶/° C., and dn/dT=190×10⁻⁶/° C., the wavelength shift Δλ/ΔT is ˜88 pm/° C. or ˜11 GHz/° C. This means that for a silicon cavity with a FSR of 3.6 nm, a temperature change of about 41° C. would cause a transmission peak shift of a full FSR. Such thermal sensitivity makes it possible to thermally tune the transmission peak of the stackable filter.

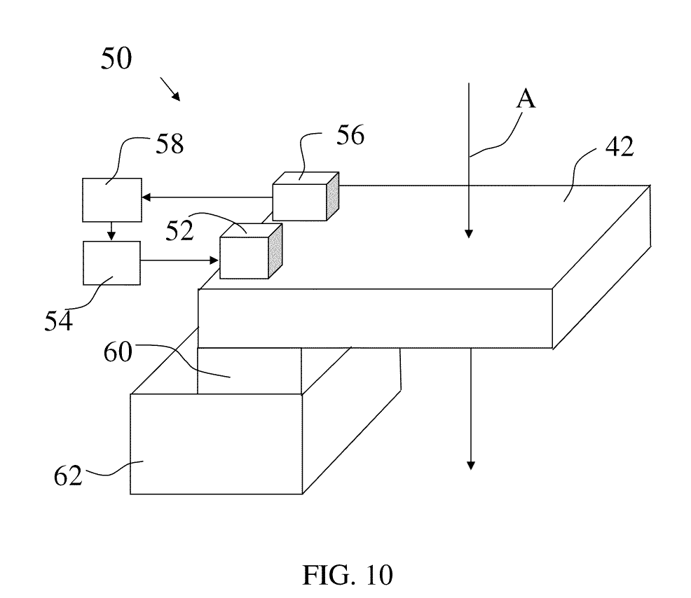

As illustrated in FIG. 10, the thermal-tuning system 50 of a filter according to the invention may be accomplished by coupling it to a small heater 52 (the two-cavity filter 42 of FIG. 5 is used here for illustration) energized by a source 54. A small thermistor 56 is also coupled to the filter to track its temperature for feedback purposes through an automated processor/controller 58 that is programmed to regulate the power supply output so as to maintain the filter's etalon spacers' temperature at the correct level to provide the desired wavelength of the transmission peak within the range of interest. A thin-layer insulator 60 is preferably used to prevent heat losses to the filter's heat sink 62 and facilitate the temperature control of the stack. The heater and insulator are preferably positioned off one side of the filter's active area and on opposite sides along the optical axis A of the filter, thereby providing a thermally stable configuration.

Thus, a simple approach has been disclosed to enable the fabrication of single-cavity filters having substantially identical optical properties suitable for stacking to produce multi-cavity filters ideal for DWDM applications. While the invention has been shown and described in what are believed to be the most practical and preferred embodiments, it is recognized that departures can be made therefrom within the scope of the invention. For example, the thermal control has been described above using temperature as the control parameter because of the direct and predictable relationship between material temperature and transmissivity. However, the optical thermal property of the material can be controlled in equivalent manner by monitoring the transmission peak wavelength and using that parameter for feedback-control purposes. Therefore, the invention is not to be limited to the details disclosed herein, but is to be accorded the full scope of the claims so as to embrace any and all equivalent apparatus and methods.

1. A method of fabricating a multiple-cavity filter for telecommunication applications, comprising the steps of:
selecting a plane-parallel optical window having a thickness suitable for the application;
coating both sides of the optical window with a quarter-wave reflector stack to produce a single-cavity filter structure;
dicing the single-cavity filter structure into a plurality of individual single-cavity filters; and
combining two or more of said single-cavity filters to produce a multi-cavity filter stack.

2. The method of claim 1, wherein said thickness of the plane-parallel optical window corresponds to a half-wave spacer.

3. The method of claim 1, wherein at least one side of said single-cavity filter structure is further coated with a coating to form an absentee layer prior to said step of combining two or more of said single-cavity filters to produce a multi-cavity filter stack.

4. The method of claim 3, wherein said thickness of the plane-parallel optical window corresponds to a half-wave spacer.

5. The method of claim 1, further including the step of polishing said sides of the optical window prior to the coating step.

6. The method of claim 5, wherein said thickness of the plane-parallel optical window corresponds to a half-wave spacer.

7. The method of claim 1, further including the step of polishing said sides of the optical window prior to the coating step; and wherein at least one side of said single-cavity filter structure is further coated with a coating to form an absentee layer prior to said step of combining two or more of said single-cavity filters to produce a multi-cavity filter stack; and wherein said thickness of the plane-parallel optical window corresponds to a half-wave spacer.

8. The method of claim 1, wherein said optical window comprises an optically thermal-sensitive material, the method further including the step of controlling the temperature of the material to cause the filter to operate with a predetermined transmission peak.

9. The method of claim 8, wherein said material is silicon.

10. A method of fabricating a multiple-cavity filter for telecommunication applications, comprising the steps of:
selecting a plane-parallel optical window having half the thickness suitable for the application;
coating one side of the optical window with a quarter-wave reflector stack;
dividing the optical window so coated into two or more components;
bonding two of said components along an uncoated side thereof to produce a single-cavity filter structure;
dicing the single-cavity filter structure into a plurality of individual single-cavity filters; and
combining two or more of said single-cavity filters to produce a multi-cavity filter stack.

11. The method of claim 10, wherein said thickness of the plane-parallel optical window corresponds to half the thickness of a half-wave spacer.

12. The method of claim 10, wherein at least one side of said single-cavity filter structure is further coated with a coating to form an absentee layer prior to said step of combining two or more of said single-cavity filters to produce a multi-cavity filter stack.

13. The method of claim 12, wherein said thickness of the plane-parallel optical window corresponds to half the thickness of a half-wave spacer.

14. The method of claim 10, further including the steps of polishing said sides of the optical window prior to the coating and bonding steps.

15. The method of claim 12, wherein said thickness of the plane-parallel optical window corresponds to half the thickness of a half-wave spacer.

16. The method of claim 10, further including the step of polishing said sides of the optical window prior to the coating step; and wherein at least one side of said single-cavity filter structure is further coated with a coating to form an absentee layer prior to said step of combining two or more of said single-cavity filters to produce a multi-cavity filter stack; and wherein said thickness of the plane-parallel optical window corresponds to a half-wave spacer.

17. The method of claim 10, wherein said optical window comprises an optically thermal-sensitive material, the method further including the step of controlling the temperature of the material to cause the filter to operate with a predetermined transmission peak.

18. The method of claim 16, wherein said material is silicon.

19. A method of fabricating a multiple-cavity filter for telecommunication applications, comprising the steps of:
selecting a plane-parallel optical window having half the thickness suitable for the application;
coating one side of the optical window with a quarter-wave reflector stack;
dicing the optical window so coated into a plurality of individual structures;
bonding pairs of said individual structures along uncoated sides thereof to produce a plurality of single-cavity filters;
combining two or more of said single-cavity filters to produce a multi-cavity filter stack.

20. The method of claim 19, wherein said thickness of the plane-parallel optical window corresponds to half the thickness of a half-wave spacer.

21. The method of claim 19, wherein said quarter-wave reflector stack is further coated with a coating to form an absentee layer prior to said dicing step.

22. The method of claim 21, wherein said thickness of the plane-parallel optical window corresponds to half the thickness of a half-wave spacer.

23. The method of claim 19, further including the steps of polishing said sides of the optical window prior to the coating and bonding steps.

24. The method of claim 23, wherein said thickness of the plane-parallel optical window corresponds to half the thickness of a half-wave spacer.

25. The method of claim 23, further including the steps of polishing said sides of the optical window prior to the coating and bonding steps; and said quarter-wave reflector stack is further coated with a coating to form an absentee layer prior to said dicing step; and wherein said thickness of the plane-parallel optical window corresponds to half the thickness of a half-wave spacer.

26. The method of claim 19, wherein said optical window comprises an optically thermal-sensitive material, the method further including the step of controlling the temperature of the material to cause the filter to operate with a predetermined transmission peak.

27. The method of claim 26, wherein said material is silicon.

28. A multi-cavity filter produced by the method of claim 1.

29. A half-wave filter stack produced by the method of claim 7.

30. A multi-cavity filter produced by the method of claim 8.

31. A multi-cavity filter produced by the method of claim 10.

32. A half-wave filter stack produced by the method of claim 16.

33. A multi-cavity filter stack produced by the method of claim 17.

34. A multi-cavity filter produced by the method of claim 19.

35. A half-wave filter stack produced by the method of claim 25.

36. A multi-cavity filter stack produced by the method of claim 26.
